(19) United States
(12) Patent Application Publication
(10) Pub. No.: US 2011/0200881 A1
(43) Pub. Date: Aug. 18, 2011

(54) ELECTRODE FOR HIGH PEFORMANCE Li-ION BATTERIES

(76) Inventors: Connie P. Wang, Mountain View, CA (US); Sergey D. Lopatin, Morgan Hill, CA (US); Robert Z. Bacharach, Burlingame, CA (US)

(21) Appl. No.: 13/023,425

(22) Filed: Feb. 8, 2011

Related U.S. Application Data
(60) Provisional application No. 61/305,176, filed on Feb. 17, 2010.
(60) Provisional application No. 61/304,176, filed on Feb. 12, 2010.

(51) Int. Cl. H01M 4/485; H01M 4/26; B05D 5/12

(52) U.S. Cl. 429/231.1; 29/730; 427/126.3

(57) ABSTRACT

A method for forming an electrode for a battery is disclosed. The method includes providing a substrate. A plurality of clusters of lithium containing compound is formed over the substrate, with each cluster having a plurality of sub-structures of lithium containing compound that exhibit nanocrystalline structure. The plurality of sub-structures of lithium containing compound are transformed to exhibit cation ordering structure. In some embodiments, a protective layer is disposed over the cluster of Li containing compound. An electrode for a battery and a system for processing the substrate are also disclosed.

### CLAIM OF PRIORITY

This application claims priority to U.S. Provisional Application No. 61/305,176 filed on Feb. 12, 2010, and entitled “Electrode for High Performance Li-Ion Batteries”, incorporated herein by reference in its entirety.

### RELATED APPLICATIONS

This application is related to commonly owned U.S. patent application Ser. No. 12/620,788 filed on Nov. 18, 2009, and entitled “Apparatus and Method for Forming 3D Nanostructure Electrode for Electrochemical Batteries and Capacitors” which is incorporated herein by reference.

### BACKGROUND

1. Field of the Invention

The present invention relates generally to batteries, and more particularly to electrodes for batteries.

2. Related Art

Batteries are commonly used electrical energy sources. A battery contains a negative electrode and a positive electrode. The negative electrode is typically called an anode and the positive electrode is typically called a cathode. The anode contains an active material that can be oxidized. The cathode contains or consumes an active material that can be reduced. The anode active material is capable of reducing the cathode active material.

When a battery is used as an electrical energy source in a device, electrical contact is made to the anode and the cathode, allowing electrons to flow through the device and permitting the respective oxidation and reduction reactions to occur to produce electrical power. An electrolyte in contact with the anode and the cathode contains ions that flow through the separator between the electrodes to maintain charge balance throughout the battery during discharge.

Batteries may be generally classified as a primary battery or a secondary battery. In a primary battery, the electrochemical reaction that takes place during discharge may not be generally reversible, by using a subsequent charging cycle. In a secondary battery, the electrochemical reaction that takes place during discharge may be reversible, by using a subsequent charging cycle.

Lithium is an attractive active material for electrodes in a battery because of lithium's high specific gravity (3800 Ah/kg) and low electronegativity (0.97). These properties lead to energy cells with high energy density and high voltage. A primary battery with lithium as active material for the anode can be built.

An example lithium-ion based secondary battery can be made up of a carbon based anode, a lithium transition metal oxide (for example, LiMn2O4, LiCoO2, LiFePO4, etc) based cathode and electrolyte containing salt (for example, LiPF6, LiBOB, etc) which serves as an ionic path for lithium ion between two electrodes. During discharge, lithium ions from the anode pass through the electrolyte to the electrochemical materials of the cathode, whereupon they release electrical energy to an external circuit.

An example secondary battery may be constructed by replacing the carbon based anode with a lithium intercalation material or compound based anode, while another lithium intercalation material is used for the cathode. The operation of such a secondary battery involves the shuttling of lithium ions back and forth between the two intercalation compounds during charge/discharge cycles. The output voltage of these types of “rocking chair” cells is determined by the difference between the electrochemical potential of lithium within the two lithium intercalating electrodes.

Application of Li-ion battery (LIB) continues to grow at a rapid speed, including usage in electrical cars, consumer electronics, etc. Active materials in cathode and anode play important role in the performance of LIB. In cathode, Lithium transition metal oxide (LiMeOx) is used as host of Li-ions. Cathode consists of small LiMeOx particles, which are then binded using binder such as Polyvinylidene fluoride (PVDF). Conductive additives, such as carbon black, are added to the cathode. In order to maintain volumetric energy of LIB, it is preferable to have LiMeOx particle size in the order of micrometers. However, for the case of cathode materials with low ion conductivity such as LiFePO4, particle size in the order of micrometers limits the rate of charging of the LIB due to slow Li ion transport caused by the size of the LiMeOx particles.

There is a need to address the volumetric energy and power density of LIB while increasing the speed of Li ion transport during charging cycles. It is in this context that the embodiments of this disclosure arise.

### SUMMARY

The concepts and methods of this disclosure allow for manufacture of cathodes for use in batteries with clusters of active materials with sub-structures, wherein the sub-structures of active material exhibit nanocrystalline phase structure. The active material may be lithium-ion containing compound.

In one aspect, the present disclosure is a method of forming an electrode for a battery. The method includes providing a substrate. A plurality of clusters of lithium containing compound is formed over the substrate, with each cluster having a plurality of sub-structures of lithium containing compound exhibiting nanocrystalline phase structure. The plurality of sub-structures of lithium containing compound are transformed to exhibit cation ordering structure. Annealing steps may be performed to initiate the transformation. In some embodiments, a protective layer is disposed over the cluster of Li containing compound.

In another aspect, an electrode for a battery is disclosed. The electrode includes a substrate. A plurality of clusters of lithium containing compound is formed over the substrate, with each cluster having a plurality of sub-structures of lithium containing compound exhibiting nanocrystalline phase structure. The plurality of sub-structures of lithium containing compound is transformed to exhibit cation ordering structure. Annealing steps may be performed to initiate the transformation. In some embodiments, a protective layer is disposed over the cluster of Li containing compound.

In yet another aspect, a system for processing a substrate is disclosed. The system includes a first process chamber is configured to form a plurality of lithium containing compound over the substrate, with each cluster having a plurality of sub-structures of lithium containing compound that exhibit nanocrystalline phase structure. A second process chamber is configured to transform the plurality of sub-structures of lithium containing compound so as to exhibit cation ordering structure. Annealing steps may be performed to initiate the transformation. In some embodiments, a protective layer is disposed over the cluster of Li containing compound.

### BRIEF DESCRIPTION OF THE DRAWINGS

These and other aspects and features of the present disclosure will become apparent to those ordinarily skilled in the art upon review of the following description of specific embodiments of the disclosure in conjunction with the accompanying figures, wherein:

FIG. 1 is an exemplary battery of this disclosure;

FIG. 2 is a process flow chart of an exemplary method for forming an electrode for the battery of FIG. 1;

FIG. 3 shows a low magnification SEM image of an exemplary electrode of this disclosure;

FIG. 4 shows cross sectional SEM image of the electrode of FIG. 3;

FIG. 5 shows a high magnification SEM image of the exemplary electrode of FIG. 3;

FIG. 6 shows a cross section of an exemplary substrate with a plurality of dendritic features, to fabricate the electrode of this disclosure;

FIG. 7 shows an exemplary system for processing the substrate, to fabricate the electrode of this disclosure; and

FIG. 8 shows an exemplary process chamber of the system of FIG. 7, configured as a PVD deposition system.

### DETAILED DESCRIPTION OF THE PREFERRED EMBODIMENTS

The present disclosure will now be described in detail with reference to the drawings, which are provided as illustrative examples of the disclosure so as to enable those skilled in the art to practice the disclosure. Notably, the figures and examples below are not meant to limit the scope of the present disclosure to a single embodiment, but other embodiments are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure. In the present specification, an embodiment showing a singular component should not be considered limiting; rather, the disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

In general, the present disclosure contemplates fabricating an electrode for a battery by providing a substrate and forming a plurality of clusters of lithium containing compound over the substrate. The clusters have a plurality of sub-structures of lithium containing compound exhibiting nanocrystalline phase structure. The plurality of sub-structures of lithium containing compound are transformed to exhibit cation ordering structure. The clusters provide volumetric energy for a lithium ion battery while the sub-structures provide smaller particles of lithium ions, permitting faster transport of Li-ion during recharging cycle.

This method is applicable to fabrication of electrodes for batteries, and more specifically to Li-ion batteries. The electrode may be used as a cathode of a Li-ion secondary battery. In some embodiments, the electrode may be used as an anode of a Li-ion secondary battery.

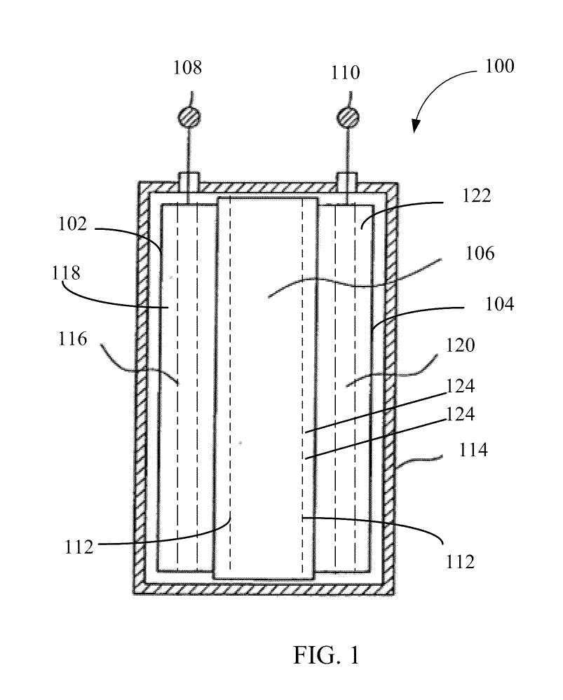

An exemplary battery that can be configured to use the electrodes of this disclosure will now be described with reference to FIG. 1. The battery 100 includes a first electrode 102, a second electrode 104 and an ion conductor 106. The first electrode 102 is connected to the first terminal 108 and the second electrode is connected to the second terminal 110. In one embodiment, the first electrode 102 is configured as an anode of the battery 100 and the second electrode is configured as a cathode of the battery 100. The first terminal 108 is configured as a positive terminal and the second terminal 110 is configured as a negative terminal. One or more separators 112 may be disposed between the first terminal 108 and the second terminal 110. The housing 114 encloses the first electrode 102, second electrode 104 and the ion conductor 106. In this disclosure, the first electrode and anode are used interchangeably, with same reference numeral. Also, the second electrode and cathode are used interchangeably, with same reference numeral.

In one embodiment, the anode 102 includes a first collector 116 and an anode active material 118 disposed over the first collector 116. The first collector 116 is preferably a material that exhibits high electrical conductivity and which is inactive to the battery electrochemical reaction. The anode active material 118 can be oxidized. In one embodiment, the anode active material 118 includes a Li-ion based compound. In one embodiment, the first collector 116 is a metallic material which is incapable of being alloyed with lithium in the electrochemical reaction. Specific examples of such metallic material are metals such as Cu, Sn, Ni, Fe, Ti, Al, and the like, and alloys of these metals. The first collector 116 may be configured to electrically couple to the first terminal 108.

In one embodiment, the cathode 104 includes a second collector 120 and a cathode active material 122 disposed over the second collector 120. The second collector 120 is preferably a material that exhibits high electrical conductivity and which is inactive to the battery chemical reaction. The cathode active material 122 is such that the anode active material 118 is capable of reducing the cathode active material 122. In one embodiment, in a secondary battery, when the anode active material 118 includes Li-ion based material, the cathode active material 122 consumes the Li-ions during the discharging cycle and the cathode active material 122 releases Li-ions during the charging cycle. In one embodiment, the second collector 120 is a metallic material which is incapable of being alloyed with lithium in the electrochemical reaction. Specific examples of such metallic material are metals such as Cu, Sn, Ni, Fe, Ti, Al, and the like, and alloys of these metals. The second collector 120 may be configured to electrically couple to the second terminal 110.

The ion conductor 106 may be an electrolyte configured to transport ions. In some embodiments, the ion conductor 106 may be a solid electrolyte. In some embodiments, the ion conductor 106 may be a gel like substance, which may be obtained by gelling an electrolyte solution using a gelling agent.

The separator 112 may include a plurality of pores 124 to permit the ions to pass through the separator 112, when the ions are transported between the first collector 116 and the second collector 120. The separator 112 may also be configured to contain and hold the ion conductor 116. Preferably, the separator 112 is made of a material that is insoluble in the ion conductor 116 material.

As one skilled in the art appreciates, the battery 100 may have various shapes and structures. For example, the battery may be of cylindrical, rectangular, prismatic or other forms of shape. The structure of the battery 100 may take a single layer structure, a spiral-wound structure, or the like. In a spiral wound cylindrical structure, the anode, cathode and the separator disposed between the anode and the cathode are wound or rolled so as to form a cylindrical structure. The first terminal and the second terminal are suitably coupled to the anode and the cathode. The ion conductor is disposed about the separator. A spiral wound cylindrical structure provides for increased surface area of the anode and cathode available for electrochemical reaction.

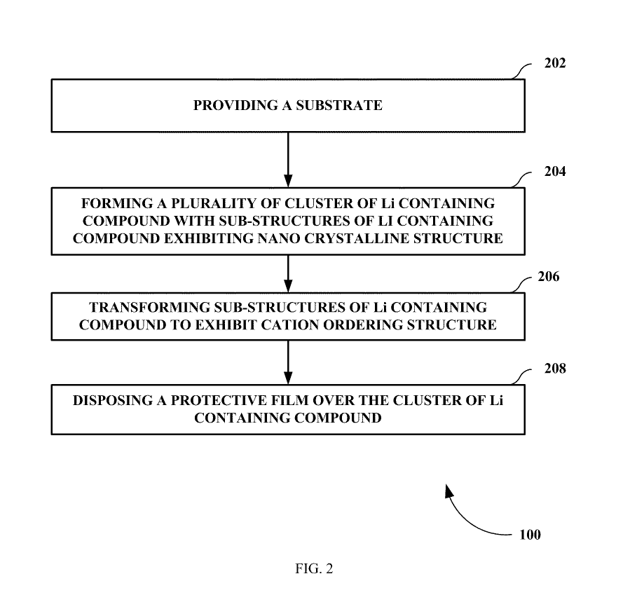

An exemplary method for fabricating an electrode for a battery, for example, battery 100 according to the current disclosure is shown in FIG. 2. The method for fabricating an electrode for a battery includes the following steps: (1) providing a substrate 202; (2) forming a plurality of clusters of lithium containing compound over the substrate, with each cluster having a plurality of sub-structures of lithium containing compound 204 exhibiting nanocrystalline structure; and (3) transforming the plurality of sub-structures of lithium containing compound to exhibit cation ordering structure 206. The method may further include disposing a protective layer over the cluster of Li containing compound 208.

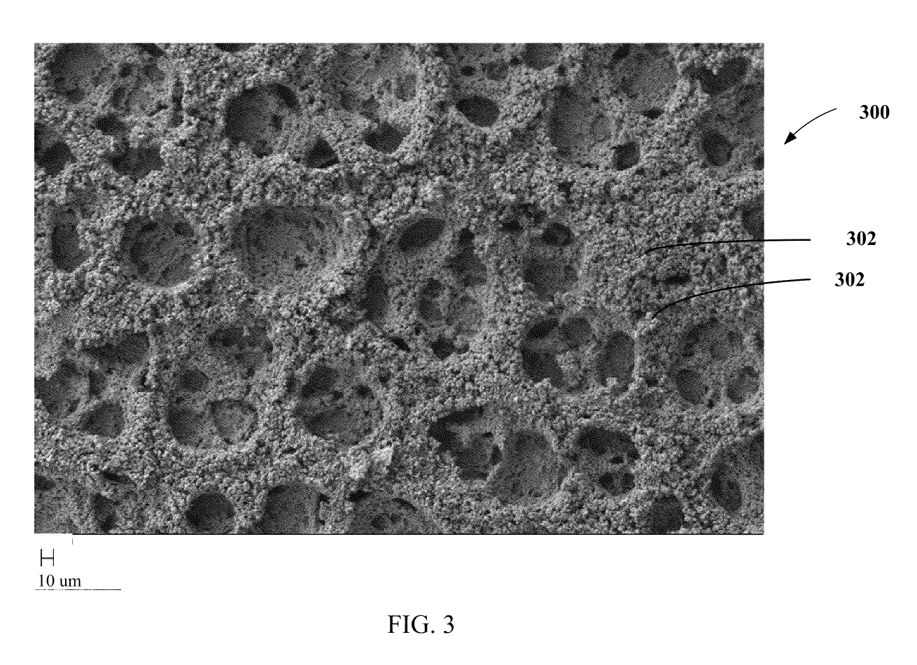

In step 202, a substrate is provided. In one embodiment, the substrate includes a plurality of dendritic features and the plurality of clusters are formed over the dendritic structure, as further described with reference to FIG. 3. In one embodiment, the substrate may be made of copper or copper alloy, for example, a copper-tin alloy. In one embodiment, the substrate may be made by a process as described in the co-pending application titled “Apparatus and Method for Forming 3D Nanostructure Electrode for Electrochemical Batteries and Capacitors” by inventors Sergey Lopatin et al., which is incorporated by reference in its entirety. In alternate embodiments, the substrate may be made of other metals or alloys of metals. For example, aluminum, titanium or alloys of aluminum and titanium may be used. It is generally preferable to choose the substrate material to be light weight, low cost and low resistivity to be a good electrical conductor.

In step 204, a plurality of clusters of lithium containing compound is formed over the substrate, with each cluster having a plurality of sub-structures of lithium containing compound exhibiting nanocrystalline structure. The plurality of clusters of lithium containing compound may be formed over the substrate using various deposition techniques. For example, for a cathode application, the Lithium containing compound may be LiCoO2, LiMn2O4. The lithium containing compounds may be a layered-oxide, for example of the form of Li(Ni,Mn,Co,Al)xOy or Olivine, for example, of the form of LiFePO4, LiMnPO4. For an anode application, Lithium containing compound may be a Lithium titanium oxide (LiTiO) compound, for example, in the form of Li4Ti5O12. The lithium containing compound may be deposited using one or more of the PVD, CVD, spray CVD or a Sol-gel type process using a solution based deposition. In some anode applications, Molybdenum oxide (MoO2) or Titanium oxide (TiO2) compound may be formed over the substrate. For example, Molybdenum oxide (MoO2) or Titanium oxide (TiO2) compound may be deposited using one or more of the PVD, CVD, spray CVD or a Sol-gel type process using a solution based deposition.

In one example, a Cu substrate was provided. The LiCoO2 was deposited using PVD deposition process, under reactive sputtering mode, in the presence of Argon and Oxygen mixture. The LiCoO2 was deposited using Endura™ PVD deposition equipment available from Applied Materials.

Next, in step 206, the plurality of sub-structures of lithium containing compound are transformed to exhibit cation ordering structure. In one embodiment, the substrate with lithium containing compound is annealed to transform the sub-structures to enhance cation ordering. The annealing temperature may be as low as 150 degree Centigrade, preferably between 350 degree Centigrade to about 700 degree centigrade. In some embodiments, the annealing temperature is maintained below about 66% of the melting temperature of the substrate material. Annealing transforms the plurality of sub-structures of lithium containing compound to exhibit cation ordering structure (i.e., ordering of Li and transition metal oxide within the lattice). The annealing can be done in air or in oxygen containing environment.

In one embodiment, in step 208, a protective layer is disposed over the cluster of Li containing compound. In one embodiment, the protective layer is deposited over the cluster of Li based compound, so as to minimize the interaction between the electrolyte and the Li containing compound in a battery application. The protective layer may be ionic conductive or metallic, so as to minimize the interaction between the electrolyte and the Li containing compound, yet not hindering the performance of the electrode. The protective layer material may be one or more of Aluminum oxide, Zinc oxide, Bismuth oxide, Aluminum phosphates, Aluminum fluoride, LiPON (a compound containing Lithium, Phosphorous, Oxygen and Nitrogen). The thickness of the protective layer may be in the range of about 0.5 nm to about 1 um. The protective coating may be applied by dipping in a solution containing the protective layer material, depositing the protective layer material by PVD or CVD process. Such protective layer is desirable to either form a stable Solid Electrolyte Interface (SEI) or to prevent SEI formation.

FIG. 3 shows low magnification SEM image of an exemplary electrode 300 with sample substrate subjected to the exemplary process. Now, referring to FIG. 3, it is evident that clusters 302 of LiCoO2 was formed over the substrate. Representative scale of the image is shown at the bottom left corner of FIG. 3.

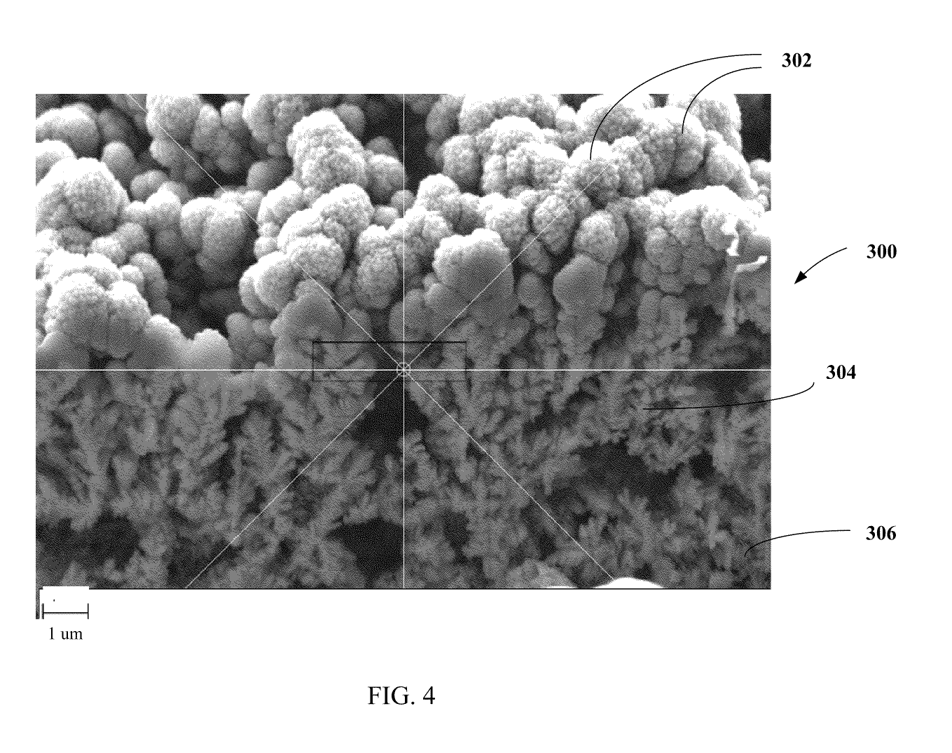

FIG. 4 is a cross-sectional SEM image of an exemplary electrode 300 with sample substrate deposited with LiCoO2. Now, referring to FIG. 4, the sample substrate 306 with dendritic features 304 is shown. Plurality of clusters 302 of LiCoO2 are formed over the substrate 306. Representative scale of the image is shown at the bottom left corner of FIG. 4. The diameter “d” of the clusters 302 of LiCoO2 are of the order of micrometers.

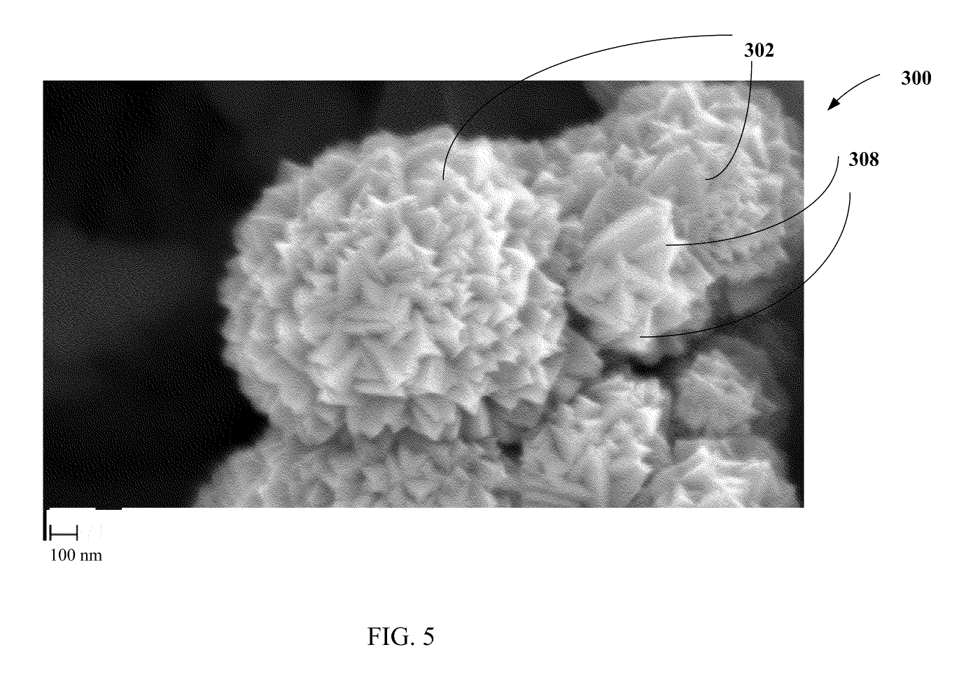

FIG. 5 shows a high magnification SEM image of an exemplary electrode 300 with the sample substrate deposited with LiCoO2. A plurality of clusters 302 of LiCoO2 is shown. Each cluster 302 has a plurality of sub-structures 308 of LiCoO2. Representative scale of the image is shown at the bottom left corner of FIG. 5. The sub-structures 308 are of order of nanometers. The sub-structures 308 exhibit nano-crystalline phase structure. For example, LiCoO2 shows a layered oxide structure. The layered oxide structure primarily exhibits a hexagonal phase structure. In some embodiments, if other Li containing compounds are used, a different nanocrystalline structure may be present. For example, if cubic phase materials, such as LiMn2O4 is used, nanocrystalline cubic phase structure may be present. Crystalline phase is preferable for ion transport. Further transport enhancement may be obtained through annealing to increase the cation ordering.

In summary, the size of the clusters 302 of LiCoO2 are in the micrometer range. The micrometer sized clusters of LiCoO2 provides higher packing density. The size of the sub-structures 308 are in nanometer range. It is expected that such nanometer sized Li containing compound will allow faster Li-ion transport, thereby increasing the speed of recharge cycle in a secondary battery.

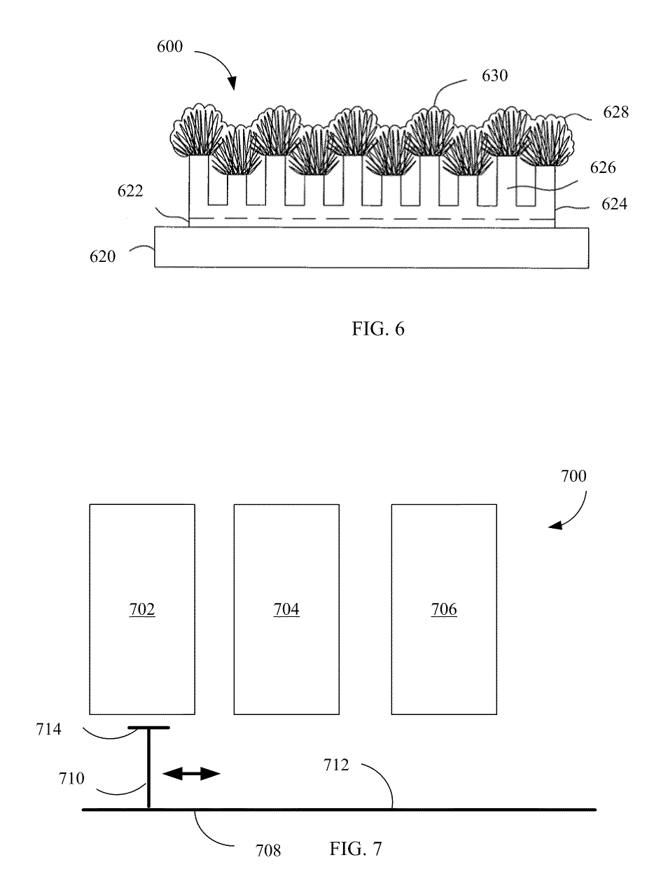

FIG. 6 shows cross section of an exemplary substrate 600 with a plurality of dendritic features. Substrate 600 may be similar to substrate 306 shown with reference to FIG. 3. The substrate 600 includes a base substrate 620, an optional barrier layer 622 deposited over the base substrate 620, an optional seed layer 624 deposited over the barrier layer 622, a columnar metal layer 626 deposited over the seed layer 624 and a porous structure 628 formed over the columnar metal layer 626.

The base substrate 620 may comprise a material selected from the group comprising copper, aluminum, nickel, zinc, tin, flexible materials, stainless steel, and combinations thereof. Flexible base substrates may be constructed from polymeric materials, such as polyimide, polyethyleneterephthalate (PET), polyacrylates, polycarbonate, silicone, epoxy resins, silicone-functionalized epoxy resins, polyester, polyethersulfones (PES), a polyetherimide, and polyethylenenaphthalene (PEN). In some cases the base substrate 620 can be constructed from a metal foil, such as stainless steel that has an insulating coating disposed thereon. Alternately, flexible substrate can be constructed from a relatively thin glass that is reinforced with a polymeric coating.

The barrier layer 222 may be optionally deposited over the base substrate 620 to prevent or inhibit diffusion of subsequently deposited materials over the barrier layer into the underlying base substrate 620. Examples of barrier layer materials include refractory metals and refractory metal nitrides such as tantalum (Ta), tantalum nitride (TaNx), titanium (Ti), titanium nitride (TiNx), tungsten (W), tungsten nitride (WNx), and combinations thereof. Other examples of barrier layer materials include PVD titanium stuffed with nitrogen, doped silicon, aluminum, aluminum oxides, titanium silicon nitride, tungsten silicon nitride, and combinations thereof. The barrier layer may be deposited by CVD, PVD, electroless deposition techniques, evaporation, or molecular beam epitaxy. The barrier layer may also be a multi-layered film deposited individually or sequentially by the same or by a combination of techniques.

The seed layer 624 comprises a conductive metal that aids in subsequent deposition of materials thereover. The seed layer 224 preferably comprises a copper seed layer or alloys thereof. Other metals, particularly noble metals, may also be used for the seed layer. The seed layer 224 may be deposited over the barrier layer 622 by techniques conventionally known in the art including physical vapor deposition techniques, chemical vapor deposition techniques, evaporation, and electroless deposition techniques.

The columnar metal layer 626 is formed over the seed layer 624. Formation of the columnar metal layer 626 includes establishing process conditions under which evolution of hydrogen results in the formation of a porous metal film. Formation of the columnar metal layer 626 generally takes place in a plating chamber using a suitable plating solution. Suitable plating solutions that may be used to plate copper may include at least one copper source compound, at least one acid based electrolyte, and optional additives.

In one embodiment, the plating solution includes at least one copper source compound, at least one acid based electrolyte, and at least one additive, such as a chelating agent. In one embodiment, the at least one copper source compound includes copper sulfate, the at least one acid based electrolyte includes sulfuric acid, and the chelating compound includes citrate salt.

The columnar metal layer 626 is formed using a high plating rate deposition process. The current densities of the deposition bias are selected such that the current densities are above the limiting current (i_{L}). When the limiting current is reached the columnar metal film is formed due to the evolution of hydrogen gas and resulting dendritic type film growth that occurs due to the mass transport limited process. During formation of the columnar metal layer, the deposition bias generally has a current density of about 10 A/cm² or less, preferably about 5 A/cm² or less, more preferably at about 3 A/cm² or less. In one embodiment, the deposition bias has a current density in the range from about 0.5 A/cm² to about 3.0 A/cm², for example, about 2.0 A/cm².

The porous structure 628 may be formed on the columnar metal layer 226 by increasing the voltage and corresponding current density from the deposition of the columnar metal layer. The deposition bias generally has a current density of about 10 A/cm² or less, preferably about 5 A/cm² or less, more preferably at about 3 A/cm² or less. In one embodiment, the deposition bias has a current density in the range from about 0.5 A/cm² to about 3.0 A/cm², for example, about 2.0 A/cm².

In one embodiment, the porous structure 628 may comprise one or more of various forms of porosities. In one embodiment, the porous structure 628 comprises macro porosity structure having pores of about 100 microns or less, wherein the non-porous portion of the macro porosity structure having pores of between about 2 nm to about 50 nm in diameter (meso porosity). In another embodiment, the porous structure 628 comprises macro porosity structure having pores of about 30 microns. Additionally, surface of the porous structure 628 may comprise nano structures. The combination of micro porosity, meso porosity, and nano structure increases surface area of the porous structure 628 tremendously.

In one embodiment, the porous structure 628 may be formed from a single material, such as copper, zinc, nickel, cobalt, palladium, platinum, tin, ruthenium, and other suitable material. In another embodiment, the porous structure 628 may comprises alloy of copper, zinc, nickel, cobalt, palladium, platinum, tin, ruthenium, or other suitable material.

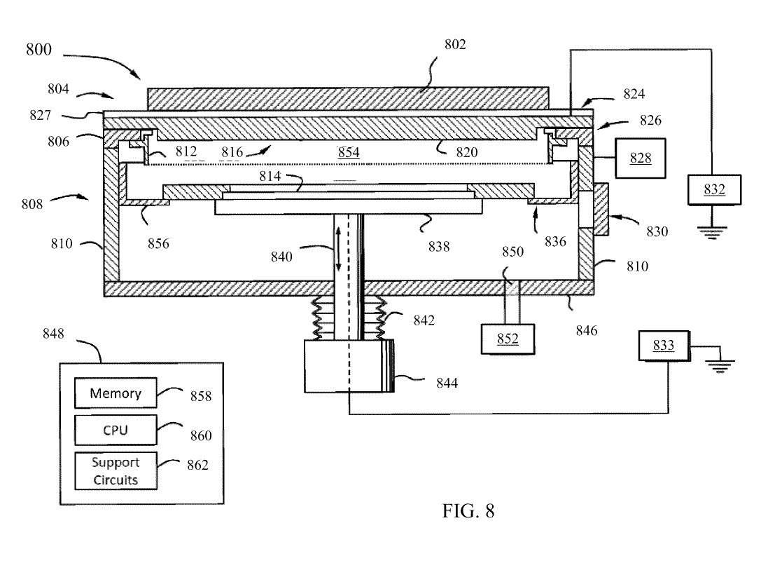

Now, referring to FIG. 7, a system 700 for processing the substrate, for example, substrate 600 and substrate 306 according to an embodiment of this disclosure is described. The system 700 may include a plurality of processing chambers, for example, process chambers 702, 704 and 706. A transport mechanism 708 may be configured to transport the substrate from one process chamber to another process chamber. Each of the process chambers 702, 704 and 706 may be configured to perform one or more of the process steps described with reference to FIG. 2 to process the substrate 600 and substrate 306.

For example, process chamber 702 may be configured to form clusters of lithium containing compound. In one embodiment, process chamber 702 may be a PVD deposition system, a CVD deposition system, a spray CVD deposition system or a sol-gel based processing chamber.

Process chamber 704 may be configured to be an annealing chamber, to anneal the substrate with lithium containing compound. In one embodiment, at least one annealing gas is supplied into the annealing chamber for thermal annealing process. Examples of annealing gases include oxygen (O₂), ozone (O₃), atomic oxygen (O), water (H₂O), nitric oxide (NO), nitrous oxide (N₂O), nitrogen dioxide (NO₂), dinitrogen pentoxide (N₂O₅), nitrogen (N₂), ammonia (NH₃), hydrazine (N₂H₄), Ar, He, derivatives thereof or combinations thereof. In one embodiment, process chamber 704 may be a tube furnace or belt furnace chamber to perform thermal annealing process. In one embodiment, the process chamber 704 may be a Vantage Radiance Plus Rapid Thermal Annealing (RTP) chamber, which is available from Applied Materials Inc. of Santa Clara, Calif.

Process chamber 706 may be configured to dispose a protective layer over the clusters of lithium containing compound. The process chamber 706 may be a PVD deposition system or a CVD deposition system to deposit a protective layer over the clusters of lithium containing compound. In one embodiment, the process chamber 706 may be a chamber configured to dip the processed substrate in a solution containing the protective layer material.

The transport mechanism 708 may be configured to transport the substrate from one process chamber to another process chamber. The transport mechanism may include a movable holder 710 that may be configured to move along a rail 712. The movable holder may include a holding mechanism 714 that is configured to load or retrieve the substrate from a process chamber. The holding mechanism 714 may also be configured to hold the substrate during transportation from one process chamber to another process chamber. The transport mechanism 708 may be an automated system or a manual system.

An exemplary PVD deposition chamber 800 is described with reference to FIG. 8. The process chambers 702 and 706 may be configured to be similar to the PVD deposition system 800. FIG. 8 illustrates an exemplary physical vapor deposition (PVD) chamber 800, also referred to as a “sputtering chamber”, “process chamber”, or a “sputter process chamber”, suitable for sputter depositing materials, for example, lithium containing compound and protective layer, according to one or more embodiment of the invention. The process chamber 800 includes a chamber body 808 having a processing volume 818 defined therein. The chamber body 808 has sidewalls 810 and a bottom 846. The dimensions of the chamber body 808 and related components of the process chamber 800 are not limited and generally are proportionally larger than the size of the substrate 600 to be processed. Any suitable substrate size may be processed and the size of the processing chamber 800 can be potentially unlimited.

A chamber lid assembly 804 is mounted on the top of the chamber body 808. The chamber body 808 may be fabricated from aluminum or other suitable materials. A substrate access port 830 is formed through the sidewall 810 of the chamber body 808, facilitating the transfer of a substrate 600 into and out of the process chamber 800. The access port 830 may be coupled to a transfer chamber and/or other chambers of a substrate processing system.

A gas source 828 is coupled to the chamber body 808 to supply process gases into the processing volume 818. In various embodiments, the process gases may include inert gases, non-reactive gases, and reactive gases. Examples of process gases that may be provided by the gas source 828 include, but not limited to, argon gas (Ar), helium (He), nitrogen gas (N₂), oxygen gas (O₂), hydrogen gas (H₂) and combinations thereof. Other processing gases are contemplated and are included within the scope of the invention.

A pumping port 850 is formed through the bottom 846 of the chamber body 808. A pumping device 852 is coupled to the process volume 818 to evacuate and control the pressure therein. In one embodiment, the pressure level of the process chamber 800 may be maintained in the range of about 10⁻¹⁰ Ton to about 1 Torr. In specific embodiments, the pressure is maintained within the range of about 6 mTorr to about 140 mTorr.

The lid assembly 804 generally includes a target 820 and a ground shield assembly 826 coupled thereto. The target 820 provides a material source that can be sputtered and deposited onto the surface of the substrate 600 during a PVD process. The lid assembly 804 may also include a chamber ceiling 827 which can be on top of the target 820, or around the target 820. In some aspects, the target 820 may act as the ceiling 827. The target 820 may be placed adjacent the chamber ceiling. The target 820 or target plate may be fabricated from a material utilized for deposition species. A very high frequency power (VHF) source 132 and a high-frequency (HF) power source 833 are connected to the target 820 to facilitate sputtering materials from the target 820. The target 820 may be fabricated from any suitable material, including both conductive and non-conductive materials.

The target 820 generally includes a peripheral portion 824 and a central portion 816. The peripheral portion 824 is disposed over the sidewalls 810 of the chamber. The central portion 116 of the target 820 may have a curvature surface slightly extending towards the surface of the substrate 600 disposed on a substrate support 838. The spacing between the target 820 and the substrate support 838 is maintained between about 50 mm and about 150 mm, but other spacing is within the scope of the invention. It is noted that the dimension, shape, materials, configuration and diameter of the target 820 may be varied for specific process or substrate requirements. In one embodiment, the target 820 may further include a backing plate having a central portion bonded and/or fabricated by a material desired to be sputtered onto the substrate surface. The target 820 may also include adjacent tiles or segment materials that together forming the target.

Optionally, the lid assembly 804 may further comprise a magnetron assembly 802 mounted above the target 820 which enhances efficient sputtering materials from the target 820 during processing. Examples of the magnetron assembly include a linear magnetron, a serpentine magnetron, a spiral magnetron, a double-digitated magnetron, a rectangularized spiral magnetron, among others.

The ground shield assembly 826 of the lid assembly 804 includes a ground frame 806 and a ground shield 812. The ground shield assembly 826 may also include other chamber shield member, target shield member, dark space shield, dark space shield frame. The ground shield 812 is coupled to the peripheral portion 824 by the ground frame 806 defining an upper processing region 854 below the central portion of the target 820 in the process volume 818. The ground frame 806 electrically insulates the ground shield 812 from the target 820 while providing a ground path to the chamber body 808 of the process chamber 800 through the sidewalls 810. The ground shield 812 constrains plasma generated during processing within the upper processing region 854 and dislodges target source material from the confined central portion 816 of the target 820, thereby allowing the dislodged target source to be mainly deposited on the substrate surface rather than chamber sidewalls 810. In one embodiment, the ground shield 812 may be formed by one or more work-piece fragments and/or a number of these pieces bonding by processes known in the art, such as welding, gluing, high pressure compression, etc.

The embodiment shown in FIG. 8 includes a shaft 840 extending through the bottom 846 of the chamber body 808 couples to a lift mechanism 844. The lift mechanism 844 is configured to move the substrate support 838 between a lower transfer position and an upper processing position. A bellows 842 circumscribes the shaft 840 and coupled to the substrate support 838 to provide a flexible seal therebetween, thereby maintaining vacuum integrity of the chamber processing volume 818.

A shadow frame 822 may be disposed on the periphery region of the substrate support 838 and is configured to confine deposition of source material sputtered from the target 820 to a desired portion of the substrate surface. A chamber shield 836 may be disposed on the inner wall of the chamber body 808 and have a lip 856 extending inward to the processing volume 818 configured to support the shadow frame 822 disposed around the substrate support 838. As the substrate support 838 is raised to the upper position for processing, an outer edge of the substrate 814 disposed on the substrate support 838 is engaged by the shadow frame 822 and the shadow frame 822 is lifted up and spaced away from the chamber shield 836. When the substrate support 838 is lowered to the transfer position adjacent to the substrate transfer port 830, the shadow frame 812 is set back on the chamber shield 836. Lift pins (not shown) are selectively moved through the substrate support 838 to lift the substrate 600 above the substrate support 838 to facilitate access to the substrate 600 by a transfer robot or other suitable transfer mechanism.

The embodiment of FIG. 8 includes a controller 848 coupled to the process chamber 800. The controller 848 includes a central processing unit (CPU) 860, a memory 858, and support circuits 862. The controller 848 is utilized to control the process sequence, regulating the gas flows from the gas source 828 into the chamber 800, the power and frequency of the VHF and HF power sources to control ion bombardment of the target 820, the density of the plasma and the degree of ionization of the sputtered species. The CPU 860 may be of any form of a general purpose computer processor that can be used in an industrial setting. The software routines can be stored in the memory 858, such as random access memory, read only memory, floppy or hard disk drive, or other form of digital storage. The support circuits 862 are conventionally coupled to the CPU 860 and may comprise cache, clock circuits, input/output subsystems, power supplies, and the like. The software routines, when executed by the CPU 860, transform the CPU into a specific purpose computer (controller) 848 that controls the process chamber 800 such that the processes are performed in accordance with the present invention. The software routines may also be stored and/or executed by a second controller (not shown) that is located remotely from the chamber 800.

During processing, the material sputtered from the target 820 is ionized in the plasma and is deposited on the surface of the substrate 600. The target 820 and the substrate support 838 are biased relative to ground by the VHF power source 832 and the HF power source 833 to maintain a plasma formed from the process gases supplied by the gas source 828, form ions within the plasma, and cause directional sputtering of the ions onto the substrate 600. Ions and excited species within the plasma strike the target 820, causing target material to be dislodged from the target 820. The dislodged target material and process gases experience energetic collisions within the plasma, resulting in the formation of ionic target materials which are accelerated toward the substrate 600, forming a layer on the substrate 600 with same composition as the target 820.

Although the present disclosure has been particularly described with reference to the preferred embodiments thereof, it should be readily apparent to those of ordinary skill in the art that changes and modifications in the form and details may be made without departing from the spirit and scope of the disclosure. It is intended that the appended claims encompass such changes and modifications.

What is claimed is:

1. A method for fabricating an electrode for a battery, comprising:
providing a substrate;
forming a plurality of clusters of lithium containing compound over the substrate, with each cluster having a plurality of sub-structures of lithium containing compound exhibiting nanocrystalline phase structure; and
transforming the plurality of sub-structures of lithium containing compound to exhibit cation ordering structure.

2. The method of claim 1, wherein forming clusters of lithium containing compound includes depositing lithium containing compound by using one or more of PVD, CVD, spray CVD, sol-gel process.

3. The method of claim 1, wherein transforming plurality of sub-structures of lithium containing compound further includes annealing the substrate with the lithium containing compound.

4. The method of claim 1, further including disposing a protective layer over the clusters of lithium containing compound.

5. The method of claim 1, wherein the substrate is a Cu or Cu alloy.

6. The method of claim 5, wherein the substrate acts as a collector.

7. The method of claim 1, wherein the electrode is a cathode for a lithium ion based secondary battery.

8. The method of claim 1, wherein the substrate including a plurality of dendritic features and the plurality of clusters of lithium containing compound formed over the plurality of dendritic features.

9. The method of claim 1, wherein the nanocrystalline structure is a layered oxide structure with a hexagonal phase structure.

10. An electrode for a battery, including:
a substrate;
clusters of lithium containing compound formed over the substrate, with each cluster having a plurality of sub-structures of lithium containing compound that exhibit nanocrystalline phase structure; and
the plurality of sub-structures of lithium containing compound transformed to exhibit cation ordering structure.

11. The electrode of claim 10, wherein the plurality of sub-structures are annealed to improve cation ordering.

12. The electrode of claim 11, wherein a protective layer is disposed over the clusters of lithium containing compound.

13. The electrode of claim 10, wherein the substrate is a Cu or Cu alloy.

14. The electrode of claim 12, wherein the substrate acts as a collector.

15. The electrode of claim 10, wherein the electrode is configured as a cathode for a battery.

16. The electrode of claim 10, wherein the electrode is configured as an anode for a battery.

17. The electrode of claim 10, wherein the substrate including a plurality of dendritic features and the plurality of clusters of lithium containing compound formed over the plurality of dendritic features.

18. The electrode of claim 10, wherein the nanocrystalline structure is a layered oxide structure with a hexagonal phase structure.

19. The electrode of claim 10, wherein the battery includes an anode and an electrolyte disposed between the anode and the cathode.

20. The electrode of claim 10, wherein the anode includes:
a substrate;
clusters of lithium containing compound formed over the substrate, with each cluster having a plurality of sub-structures of lithium containing compound that exhibit nanocrystalline phase structure; and
the plurality of sub-structures of lithium containing compound transformed to exhibit cation ordering structure.

21. A system for processing a substrate, comprising:
a first process chamber configured to form a plurality of lithium containing compound over the substrate, with each cluster having a plurality of sub-structures of lithium containing compound that exhibit nanocrystalline phase structure; and
a second process chamber configured to transform the plurality of sub-structures of lithium containing compound so as to exhibit cation ordering structure.

22. The system of claim 21 wherein the plurality of sub-structures are annealed in the second chamber, to improve cation ordering.

23. The system of claim 21, further including a third process chamber configured to dispose a protective layer over the clusters of lithium containing compound.

24. The system of claim 21, wherein the substrate is a Cu, or Cu alloy.

25. The system of claim 21, wherein the substrate including a plurality of dendritic features and the plurality of clusters of lithium containing compound are formed over the plurality of dendritic features.
